(19) United States
(12) Patent Application Publication
(10) Pub. No.: US 2024/0412010 A1
(43) Pub. Date: Dec. 12, 2024

(54) VEHICLE INTERFACE CONTROL

(71) Applicant: Ford Global Technologies, LLC, Dearborn, MI (US)

(72) Inventors: Keith Weston, Canton, MI (US); Brendan Francis Diamond, Grosse Pointe, MI (US); Stuart C. Salter, White Lake, MI (US); John Robert Van Wiemeersch, Novi, MI (US)

(73) Assignee: Ford Global Technologies, LLC, Dearborn, MI (US)

(21) Appl. No.: 18/332,012

(22) Filed: Jun. 9, 2023

(51) Int. Cl. G06F 40/47; G10K 11/178; G10L 15/22; G10L 15/25; G10L 15/26; G10L 25/57; H04R 1/02; H04R 1/08

(52) U.S. Cl. CPC G06F 40/47; G10K 11/17823; G10K 11/17873; G10L 15/22; G10L 15/25; G10L 15/26; G10L 25/57; H04R 1/025; H04R 1/08; G10K 2210/1282; G10K 2210/3027; G10K 2210/3044; G10L 13/02; H04R 2499/13

(57) ABSTRACT

An audio system for a vehicle includes a microphone focused on a first designated location of a first person with respect to the vehicle, a camera with a field of view encompassing the first designated location, an output device directed to a second designated location of a second person with respect to the vehicle, and a computer communicatively coupled to the microphone, the camera, and the output device. The computer is programmed to generate first text in a first language based on input audio data from the microphone and video data from the camera, translate the first text to second text in a second language, and instruct the output device to output the second text.

### BACKGROUND

In some situations, an occupant of a vehicle may wish to communicate with another individual, who could be inside or outside the vehicle. Many factors affect such communication and can impair and/or prevent a vehicle occupant and another individual from communicating.

### BRIEF DESCRIPTION OF THE DRAWINGS

FIG. 1 is a perspective view of an example vehicle.

FIG. 2 is a top view of the vehicle with a passenger compartment exposed for illustration.

FIG. 3 is a block diagram of an example system of the vehicle.

FIG. 4 is a flowchart of an example process for controlling the system.

### DETAILED DESCRIPTION

This disclosure describes a system for communication between an occupant of a vehicle and another person, and can support communication where the other person speaks a different language from the occupant. The other person may be another occupant or may be a person such as a pedestrian outside the vehicle. The system includes a microphone focused on a first designated location of a first person with respect to the vehicle, a camera with a field of view encompassing the first designated location, an output device directed to a second designated location of a second person with respect to the vehicle, and a computer communicatively coupled to the microphone, the camera, and the output device. The output device may be, e.g., a speaker or a display. The use of the designated locations can specify locations where individuals are likely to be present, e.g., in seats of the vehicle or outside the vehicle next to a door of the vehicle. The computer is programmed to generate first text in a first language based on input audio data from the microphone and video data from the camera, translate the first text to second text in a second language, and instruct the output device to output the second text. The computer may use the video data to supervise the generation of the first text from speech detected in the input audio data, thereby increasing the accuracy of the speech-to-text conversion.

A system for a vehicle includes a microphone focused on a first designated location of a first person with respect to the vehicle, a camera with a field of view encompassing the first designated location, an output device directed to a second designated location of a second person with respect to the vehicle, and a computer communicatively coupled to the microphone, the camera, and the output device. The computer is programmed to generate first text in a first language based on input audio data from the microphone and video data from the camera, translate the first text to second text in a second language, and instruct the output device to output the second text.

In an example, the first designated location may be exterior to and adjacent to the vehicle. In a further example, the microphone may be mounted to an exterior of the vehicle, and the field of view of the camera may encompass an area outside the vehicle.

In an example, the first designated location may be in a passenger compartment of the vehicle. In a further example, the first designated location may be in a seat of the vehicle, the microphone may be positioned to receive audio from the first person sitting in the seat, and the field of view of the camera may encompass the seat.

In an example, the second designated location may be in a passenger compartment of the vehicle. In a further example, the output device may be a speaker, the second designated location may be in a seat of the vehicle, and the speaker may be mounted to the seat.

In an example, the second designated location may be exterior to and adjacent to the vehicle.

A computer includes a processor and a memory, and the memory stores instructions executable by the processor to generate first text in a first language based on input audio data from a microphone and video data from a camera, translate the first text to second text in a second language, and instruct an output device to output the second text. The microphone is focused on a first designated location of a first person with respect to a vehicle, and the camera has a field of view encompassing the first designated location. The output device is directed to a second designated location of a second person with respect to the vehicle.

In an example, the instructions to generate the first text may include instructions to generate audio-based text based on the input audio data, generate video-based text based on the video data, and combine the audio-based text and the video-based text into the first text. In a further example, the instructions may further include instructions to generate an audio-based confidence level of the audio-based text and a video-based confidence level of the video-based text, and the instructions to combine the audio-based text and the video-based text into the first text may include instructions to combine the audio-based text and the video-based text into the first text based on the audio-based confidence level and the video-based confidence level. In a yet further example, the audio-based text may include a sequence of audio-based words, the video-based text may include a sequence of video-based words, the audio-based confidence level may include a sequence of audio-based confidence values for the respective audio-based words, and the video-based confidence level may include a sequence of video-based confidence values for the respective video-based words. In a still yet further example, the instructions to combine the audio-based text and the video-based text into the first text may include instructions to select a word for the first text from either the audio-based words or the video-based words according to which of the respective audio-based confidence value or video-based confidence value is greater.

In an example, the instructions to generate the first text may include instructions to execute a speech-to-text algorithm on the input audio data.

In an example, the instructions to generate the first text may include instructions to execute a lip-reading algorithm on the video data. In a further example, the lip-reading algorithm may output video-based text, and the instructions to generate the first text may include instructions to execute a speech-to-text algorithm on the input audio data to output audio-based text, and combine the audio-based text and the video-based text into the first text.

In an example, the output device may be a speaker, and the instructions may further include instructions to generate output audio data from the second text, and to instruct the speaker to play the output audio data. In a further example, the instructions may further include instructions to generate cancellation audio data based on the input audio data, and instruct the speaker to play the cancellation audio data. In a still further example, the instructions may further include instructions to instruct the speaker to play the output audio data and the cancellation audio data simultaneously.

A method includes generating first text in a first language based on input audio data from a microphone and video data from a camera, translating the first text to second text in a second language, and instructing an output device to output the second text. The microphone is focused on a first designated location of a first person with respect to a vehicle, and the camera has a field of view encompassing the first designated location. The output device is directed to a second designated location of a second person with respect to the vehicle.

With reference to the Figures, wherein like numerals indicate like parts throughout the several views, a system 105 for a vehicle 100 includes a microphone 115, 215 focused on a first designated location 110 of a first person with respect to the vehicle 100, a camera 120, 220 with a field of view encompassing the first designated location 110, an output device 125, 135, 210, 225 directed to a second designated location 110 of a second person with respect to the vehicle 100, and a computer 300 communicatively coupled to the microphone 115, 215, the camera 120, 220, and the output device 125, 135, 210, 225. The computer 300 is programmed to generate first text in a first language based on input audio data from the microphone 115, 215 and video data from the camera 120, 220, translate the first text to second text in a second language, and instruct the output device 125, 135, 210, 225 to output the second text.

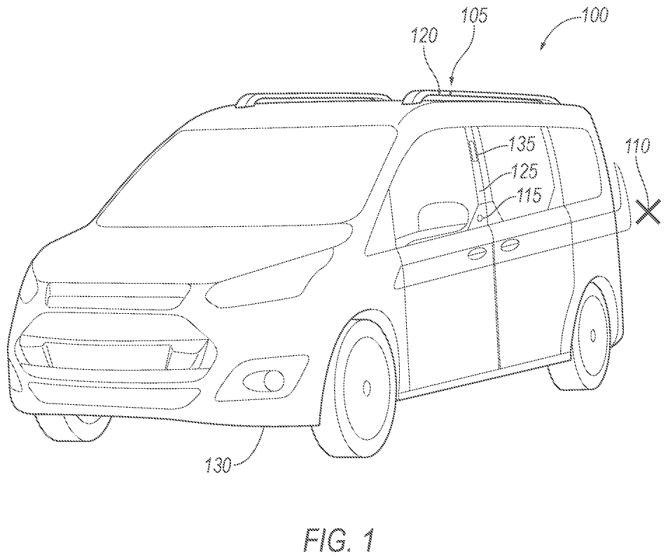

With reference to FIG. 1, the vehicle 100 may be any passenger or commercial automobile such as a car, a truck, a sport utility vehicle, a crossover, a van, a minivan, a taxi, a bus, etc.

The vehicle 100 includes a body 130. The vehicle 100 may be of a unibody construction, in which a frame and the body 130 of the vehicle 100 are a single component. The vehicle 100 may, alternatively, be of a body-on-frame construction, in which the frame supports the body 130 that is a separate component from the frame. The frame and body 130 may be formed of any suitable material, for example, steel, aluminum, etc.

The system 105 of the vehicle 100 may include at least one external camera 120. The external camera 120 is mounted on the vehicle 100, e.g., to the body 130 of the vehicle 100. The external camera 120 is aimed outside the vehicle 100, i.e., has a field of view encompassing an area outside the vehicle 100, e.g., is oriented away from the vehicle 100, e.g., and aimed laterally relative to the vehicle 100, i.e., has a field of view encompassing a line or plane orthogonal to a front-rear length or axis of the vehicle. For example, the external camera 120 may be mounted to a roof rack, a middle pillar, a door handle, an interior door sill trim, etc. The field of view of the external camera 120 encompasses one of the designated locations 110 of the vehicle 100, specifically a designated location 110 external to the vehicle 100. This orientation can detect a pedestrian outside the vehicle 100 who intends to talk to an occupant of the vehicle 100, e.g., a pedestrian that has approached the doors of the vehicle 100 or a worker in a tollbooth or order window that the vehicle 100 has approached.

The external camera 120 can detect electromagnetic radiation in some range of wavelengths. For example, the external camera 120 may detect visible light, infrared radiation, ultraviolet light, or some range of wavelengths including visible, infrared, and/or ultraviolet light. For example, the external camera 120 can be a charge-coupled device (CCD), complementary metal oxide semiconductor (CMOS), or any other suitable type.

The system 105 of the vehicle 100 may include at least one external microphone 115. The external microphone 115 may be mounted outside a passenger compartment 200 of the vehicle 100, e.g., attached to outward-facing components of the vehicle 100. The external microphone 115 may be directed externally to the vehicle 100, i.e., arranged to detect sounds originating from sources spaced from the vehicle 100. For example, the external microphone 115 may be mounted to an exterior of the vehicle 100, e.g., possibly be part of a door panel of the exterior. The external microphone 115 may be mounted on a side of the vehicle 100, e.g., the driver side of the vehicle 100 as shown in the Figures. The external microphone 115 focused on one of the designated locations 110 of the vehicle 100, specifically a designated location 110 external to the vehicle 100, e.g., the designated location 110 encompassed by the field of view of the external camera 120.

The external microphone 115 is a transducer that converts sound into electrical signals. The external microphone 115 may be any suitable type for receiving sound from someone talking outside the vehicle 100, e.g., a dynamic microphone, a condenser microphone, a piezoelectric microphone, a transducer-on-glass microphone, a transducer-on-trim microphone, etc. If the external microphone 115 is a transducer-on-trim microphone, the external microphone 115 may be part of the door panel. An advantage of the external microphone 115 being a transducer-on-trim microphone is that it is more difficult for environmental factors to interfere with performance of a transducer-on-trim microphone. The same is true for transducer-on-glass. A single piece of debris (e.g., dirt, mud, ice, snow) can significantly block or attenuate other types of microphones than transducer-on-trim or transducer-on-glass microphones from sampling sounds.

The system 105 of the vehicle 100 may include at least one external speaker 125. The external speaker 125 may be mounted outside the passenger compartment 200 of the vehicle 100, e.g., attached to outward-facing components of the vehicle 100, mounted in the passenger compartment 200, or both. The external speaker 125 is directed externally to the vehicle 100, i.e., arranged to project sound away from the vehicle 100, even if mounted inside the passenger compartment 200. The external speaker 125 is directed to one of the designated locations 110 of the vehicle 100. For example, the external speaker 125 may be mounted to the door panel directly outboard of a pillar of the vehicle 100. The external speaker 125 may be mounted to the same side of the vehicle 100 as the external microphone 115 and/or external camera 120, e.g., directed to the same designated location 110 as the external microphone 115 and/or external camera 120. For another example, when mounted inside the passenger compartment 200, the external speakers 125 can be used when the window has been rolled down, either to augment or be used in place of another external speaker 125 mounted on an exterior of the vehicle 100, to provide higher fidelity audio to support clarity.

The external speaker 125 may be any suitable type of speaker audible to someone when they are relatively close to the vehicle 100. In particular, the external speaker 125 may be a panel exciter, i.e., which generates sound by vibrating a rigid panel. For example, an electric motor may be adhered to an inboard side of the door panel and impart vibrations to the door panel to generate sound. Alternatively, or additionally, an electric motor (ex., piezoelectric transducer) may be adhered to an inboard side of a rigid glass sheet and impart vibrations to the glass sheet to generate sound. An advantage of the external speaker 125 being a panel or sheet exciter rather than a point speaker is that it is more difficult for environmental factors to interfere with performance of the external speaker 125. A single piece of debris (e.g., dirt, mud, ice, snow) can significantly block or attenuate sound from a point speaker but not from a panel exciter.

The system 105 may include at least one display screen 135. The display screen 110 is positioned to display on an exterior of the vehicle 100, and is thus outside the passenger compartment 200 of the vehicle 100. For example, the display screen 135 can be mounted to the body 130 of the host vehicle 100, e.g., a middle pillar of the body 130, or to a door panel of a door of the vehicle 100. The display screen 135 on the door panel can be directly outboard of the middle pillar. Mounting the display screen 135 next to the middle pillar can locate the display screen 135 next to the position of an occupant in the passenger compartment 200 regardless of whether the occupant is in the front or rear of the vehicle 100. The display screen 110 is thus easily visible to someone approaching one of the doors of the vehicle 100. For another example, the display screen 110 can include a projector such as a Digital Light Projector (DLP) mounted in the passenger compartment 200 that throws a display image on a window of the vehicle 100. The window can include a film that is reactive to light of particular wavelengths, e.g., light projected by the projector onto the window. For example, the film can include a phosphor coating or a quantum dot coating.

The display screen 110 can be any suitable type for displaying content legible to a person standing outside the host vehicle 100, e.g., light-emitting diode (LED), organic light-emitting diode (OLED), liquid crystal display (LCD), plasma, digital light processing technology (DLPT), etc. The display screen 110 can be a touchscreen and can accept inputs.

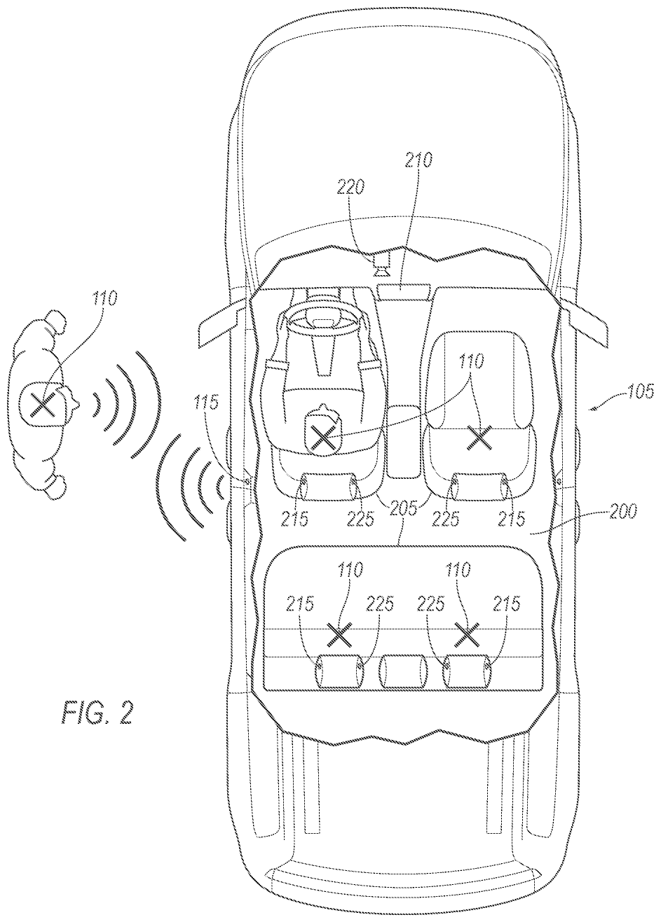

With reference to FIG. 2, the vehicle 100 includes the passenger compartment 200 to house occupants, if any, of the vehicle 100. The passenger compartment 200 includes a plurality of seats 205, e.g., one or more of the seats 205 disposed in a front row of the passenger compartment 200 and one or more of the seats 205 disposed in a second row behind the front row. The passenger compartment 200 may also include seats 205 in a third row (not shown) at a rear of the passenger compartment 200.

The system 105 may include a user interface 210. The user interface 210 presents information to and receives information from an occupant of the vehicle 100. The user interface 210 may be located, e.g., on an instrument panel in the passenger compartment 200 of the vehicle 100, or wherever it may be readily seen by the occupant. The user interface 210 may include dials, digital readouts, screens, and so on for providing information to the occupant, e.g., human-machine interface (HMI) elements such as are known. The user interface 210 may include buttons, knobs, keypads, and so on for receiving information from the occupant.

The area in and around the vehicle 100 contains a plurality of the designated locations 110. Each designated location 110 is a preset location in space defined relative to the vehicle 100, e.g., defined as a three-dimensional coordinate in a reference frame of the vehicle 100. The designated locations 110 are chosen as likely locations of an occupant of the vehicle 100 or of a pedestrian conversing with occupants of the vehicle 100. Some of the designated locations 110 are in the passenger compartment 200 of the vehicle 100, e.g., one designated location 110 in each seat 205 of the vehicle 100. For example, the vehicle 100 may include four designated locations 110, each at a location of a head of a 50th percentile occupant sitting in one of the seats 205. One or more of the designated locations 110 may be located exterior to and adjacent to the vehicle 100, e.g., adjacent to the doors of the vehicle 100. For example, the vehicle 100 may include two designated locations 110 external to the vehicle 100, each at an average lateral distance and height of a tollbooth window or drive-thru window relative to the vehicle 100. The designated locations 110 provide reference points for the arrangement of the cameras 120, 220, the microphones 115, 215, and the speakers 125, 225. Each designated location 110 may have at least one camera 120, 220, at least one microphone 115, 215, and at least one speaker 125, 225 covering that designated location 110.

The system 105 includes at least one internal camera 220. The internal camera 220 has a field of view encompassing at least one of the designated locations 110, e.g., encompassing at least one of the seats 205. For example, the internal camera 220 may be mounted to an instrument panel forward of the seats 205 and face rearward. The internal camera 220 may have the same functionality as described above for the external camera 120.

The system 105 includes at least one internal microphone 215. Each internal microphone 215 is focused on a respective designated location 110 of the vehicle 100, e.g., is positioned to receive audio from an occupant sitting in a respective seat 205. For example, the internal microphones 215 may be mounted to the respective seats 205, e.g., to head restraints of the seats 205. The internal microphones 215 are transducers that convert sound into an electrical signal. The internal microphones 215 may be any suitable type for receiving sound from occupants of the vehicle 100, e.g., dynamic microphones, condenser microphones, piezoelectric microphones, etc.

The system 105 includes at least one internal speaker 225. Each internal speaker 225 is directed to a respective designated location 110 of the vehicle 100, e.g., is positioned to emit audio to an occupant sitting in a respective seat 205. For example, the internal speakers 225 may be mounted to the respective seats 205, e.g., to head restraints of the seats 205. The internal speakers 225 can be any suitable type of speaker for outputting sound to occupants of the passenger compartment 200, e.g., dynamic loudspeakers.

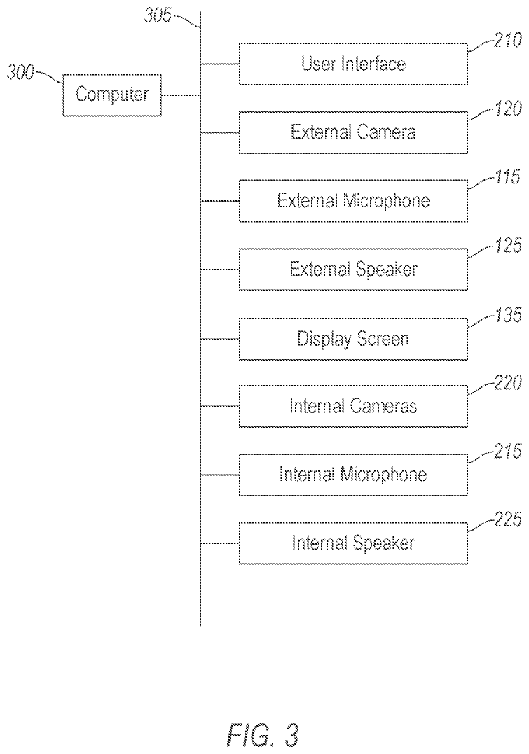

With reference to FIG. 3, the system 105 includes the computer 300. The computer 300 is a microprocessor-based computing device, e.g., a generic computing device including a processor and a memory, an electronic controller or the like, a field-programmable gate array (FPGA), an application-specific integrated circuit (ASIC), a combination of the foregoing, etc. Typically, a hardware description language such as VHDL (VHSIC (Very High Speed Integrated Circuit) Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g., stored in a memory electrically connected to the FPGA circuit. The computer 300 can thus include a processor, a memory, etc.

The memory of the computer 300 can include media for storing instructions executable by the processor as well as for electronically storing data and/or databases, and/or the computer 300 can include structures such as the foregoing by which programming is provided. The computer 300 can be multiple computers coupled together.

The system 105 may include a communications network 305. The computer 300 may transmit and receive data through the communications network 305. The communications network 305 may be, e.g., a controller area network (CAN) bus, Ethernet, Wi-Fi, Local Interconnect Network (LIN), and/or any other wired or wireless communications network. The computer 300 may be communicatively coupled to the microphones 115, 215, the cameras 120, 220, the speakers 125, 225, the display screen 135, the user interface 210, and other components via the communications network 305.

Returning to FIG. 1-2, the system 105 can facilitate a conversation between occupants and/or pedestrians in different designated locations 110 of the vehicle 100. The description below is for one side of the conversation, with an individual talking in a first designated location 110 and an individual listening in a second designated location 110. The description below may simultaneously be reversed, i.e., from the second designated location 110 to the first designated location 110, for the other side of the conversation. Alternatively, the system 105 may work one-way, with one individual broadcasting from a first designated location 110 to one or more occupants in one or more second designated location 110, without a reverse transmission.

The computer 300 may be programmed to receive a selection of one or more designated locations 110 including a first designated location 110 and at least one second designated location 110, e.g., via the user interface 210. The first designated location 110 refers to the designated location 110 of the person speaking, and the second designated location 110 refers to the designated location 110 of the person listening. For example, the selection may be for two designated locations 110, and the computer 300 may perform the steps below for each of the two designated locations 110 to the other designated location 110 in order to facilitate a conversation between persons in those two designated locations 100. For another example, the selection may be for a first designated location 110 at which a person will speak and one or more second designated locations 110 at which persons will listen.

The computer 300 is programmed to receive input audio data from one of the microphones 115, 215, i.e., the microphone 115, 215 focused on a first designated location 110.

The microphone 115, 215 generates the input audio data. The input audio data is recorded sound data in any suitable format, e.g., a standard audio file format such as .wav. Audio data includes sound as a function at least of time. For example, audio data may be represented as a spectrogram, which shows amplitude as a function of time and frequency.

The computer 300 is programmed to receive video data from one of the cameras 120, 220, i.e., the camera 120, 220 with a field of view encompassing the first designated location 110. The camera 120, 220 generates the video data. The video data are sequences of image frames depicting the scenes contained in the field of view of the camera 120, 220. Each image frame is a two-dimensional matrix of pixels. Each pixel has a brightness and/or color represented as one or more numerical values, e.g., a scalar unitless value of photometric light intensity between 0 (black) and 1 (white), or values for each of red, green, and blue, e.g., each on an 8-bit scale (0 to 255) or a 12-or 16-bit scale. The pixels may be a mix of representations, e.g., a repeating pattern of scalar values of intensity for three pixels and a fourth pixel with three numerical color values, or some other pattern. Position in the image frame, i.e., position in the field of view of the sensor at the time that the image frame was recorded, can be specified in pixel dimensions or coordinates, e.g., an ordered pair of pixel distances, such as a number of pixels from a top edge and a number of pixels from a left edge of the field of view.

The input audio data is associated with the video data, e.g., is recorded in the scene depicted in the video data contemporaneously with recording the video data. For example, the input audio data may be time-synchronized to the video data.

The computer 300 may be programmed to generate audio-based text based on the input audio data. For example, the computer 300 may execute a speech-to-text algorithm on the input audio data to output the audio-based text. The computer 300 can use any suitable speech-to-text algorithm for converting speech to text, e.g., hidden Markov models, dynamic time warping-based speech recognition, neural networks, end-to-end speech recognition, etc. The computer 300 may generate the audio-based text without using the video data. The audio-based text includes a sequence of words, which will be referred to as the audio-based words.

The computer 300 may be programmed to generate video-based text based on the video data. For example, the computer 300 may execute a lip-reading algorithm on the video data to output the video-based text. The computer 300 can use any suitable lip-reading algorithm for generating the video-based text, e.g., a sequence including a convolutional neural network (CNN) trained to localize lips in images, a CNN trained to extract features related to the shape of the lips, and a machine-learning algorithm such as a long short-term memory (LSTM) algorithm for selecting words based on the extracted features. The LSTM algorithm is useful for selecting words based on the context of the surrounding words. The computer 300 may generate the video-based text without using the input audio data. The video-based text includes a sequence of words, which will be referred to as the video-based words.

The computer 300 may be programmed to generate confidence levels of the audio-based text and video-based text. For the purposes of this disclosure, a “confidence level” is defined as measure of the likelihood of generated text matching the corresponding actual spoken words. The confidence level of the audio-based text will be referred to as the audio-based confidence level, and the confidence level of the video-based text will be referred to as the video-based confidence level. The audio-based confidence level may include a sequence of audio-based confidence values for the respective audio-based words, and the video-based confidence level may include a sequence of video-based confidence values for the respective video-based words. The audio-based confidence values may be generated by the speech-to-text algorithm, e.g., as a score accompanying a respective audio-based word. For example, the speech-to-text algorithm may generate an audio-based word by generating scores for a plurality of candidate words and selecting the candidate word with the highest score. That highest score for the selected audio-based word may be taken as the audio-based confidence value for that audio-based word. The video-based confidence values may be generated in a similar manner by the lip-reading algorithm, e.g., by the LSTM algorithm within the lip-reading algorithm.

The computer 300 is programmed to generate first text based on the input audio data from the microphone 115, 215 and the video data from the camera 120, 220. The computer 300 may combine the audio-based text generated from the input audio data and the video-based text generated from the video data into the first text, e.g., based on the audio-based confidence level and the video-based confidence level. For example, the computer 300 may select a word for the first text from either the audio-based words or the video-based words according to which of the respective audio-based confidence value or video-based confidence value is greater. The audio-based words and video-based words may be associated in a sequence of pairs, with each pair including one audio-based word and one video-based word, according to the time-synchronization of the input audio data and the video data. The computer 300 selects a word from each pair. To give a specific example, if a sequence of five pairs of words has audio-based confidence values of {0.80, 0.84, 0.71, 0.56, 0.75} and video-based confidence values of {0.65, 0.73, 0.67, 0.71, 0.69},then the computer 300 selects the first audio-based words from the first three pairs, the video-based word from the fourth pair, and the audio-based word from the fifth pair as the words in the first text. One or both of the audio-based confidence values and video-based confidence values may be scaled so that the confidence values are commensurable.

The first text is in a first language. The computer 300 may be programmed to receive or determine the first language. For example, the occupant at the first designated location 110 may provide an input to the user interface 210 selecting the first language. The first language may be a default language unless the occupant has made a selection. For another example, the computer 300 may identify the occupant in the first designated location 110, e.g., based on a login provided by the occupant, facial recognition using the video data, pairing of a mobile device belonging to the occupant with the user interface 210, etc., and the computer 300 may then identify a language stored in a profile of the identified occupant. For another example, the computer 300 may identify the first language based on the first text using a language-recognition algorithm. The speech-to-text algorithm and the lip-reading algorithm may be programmed or trained for the first language.

The computer 300 may be programmed to receive a second language for the second designated location 110. For example, the occupant at the second designated location 110 may provide an input to the user interface 210 selecting the second language for the second designated location 110. The second language may be a default language unless the occupant has made a selection. For another example, the computer 300 may select a language based on a GPS location and/or heading of the vehicle 100. The computer 300 may determine that the vehicle 100 is located inside a geofenced area or is approaching a geofenced area. For a specific example, the computer 300 may select French in response to the vehicle 100 traveling from the United States into Canada at a crossing near Montreal. For another example, the computer 300 may identify the occupant at the second designated location 110, e.g., based on a login provided by the occupant, facial recognition using the video data, pairing of a mobile device belonging to the occupant with the user interface 210, etc., and the computer 300 may then identify a language stored in a profile of the identified occupant.

The computer 300 is programmed to translate the first text in the first language to second text in the second language. The computer 300 may use any suitable machine translation algorithm for translating from the first language to the second language, e.g., rule-based machine translation such as transfer-based machine translation, interlingual machine translation, or dictionary-based machine translation; statistical machine translation such as example-based machine translation; hybrid machine translation combining rule-based and statistical; neural machine translation, e.g., using deep learning; etc. The machine translation algorithm may receive the first text, the first language, and the second language as inputs and provide the second text as output. Alternatively, the computer 300 may select from different machine translation algorithms based on the selections of the first language and the second language according to their performances translating from the first language to the second language, and the selected machine translation algorithm receives the first text as input and provides the second text as output.

The computer 300 is programmed to instruct the output device 125, 135, 210, 225 to output the second text. The output device 125, 135, 210, 225 may be one of the speakers 125, 225 and/or a visual output device such as the display screen 135 or the user interface 210. For example, the computer 300 may generate output audio data from the second text and instruct one of the speakers 125, 225 to play the output audio data, as will be described below. Alternatively or additionally, the computer 300 may instruct one of the visual output devices 135, 210 to display the second text, as will be described below.

The computer 300 is programmed to generate output audio data from the second text. For example, the computer 300 may execute a text-to-speech algorithm on the second text to output the output audio data. The computer 300 can use any suitable text-to-speech algorithm, e.g., concatenative synthesis such as unit selection synthesis, diphone synthesis, or domain-specific synthesis; formant synthesis; articulatory synthesis; hidden Markov models; deep learning-based synthesis; etc.

The computer 300 may be programmed to generate cancellation audio data based on the input audio data. The computer 300 may execute an active-noise-cancellation algorithm to produce the cancellation audio data that cancels the input audio data. The active-noise-cancellation algorithm may either invert or phase shift the sound wave contained in the input audio data, resulting in the cancellation audio data. Playing the cancellation audio data can cause destructive interference with the sound that produced the input audio data.

The computer 300 is programmed to instruct the speaker 125, 225 for the second designated location 110 to play the output audio data. The computer 300 may instruct the speaker 125, 225 to play the output audio data at a volume that is typically intelligible by an occupant at the second designated location 110 and inaudible or at least unintelligible to occupants in other designated locations 110, e.g., the first designated location 110, which is facilitated by the speaker 125, 225 being directed to the second designated location 110. The system 105 thus provides zonal output, i.e., different audio outputted for different zones of the vehicle 100.

The computer 300 may be programmed to instruct the speaker 125, 225 to play the cancellation audio data, e.g., to play the output audio data and the cancellation audio data simultaneously. The computer 300 may instruct the speaker 125, 225 to play the cancellation audio data at a volume proportional to the volume of the sound that produced the input audio data, to facilitate the destructive interference. The noise cancellation helps the system 105 provide zonal output by decreasing the sound from other designated locations 110 that is perceptible at the second designated location 110, thereby helping the person at the second designated location 110 to more easily understand the output audio data.

The computer 300 may be programmed to instruct the visual output device 135, 210 to display the second text, i.e., output a visual representation of the second text. For example, the computer 300 may instruct the visual output device 135, 210 to display the second text as text on the visual output device 135, 210, thereby providing a text translation of the speech by the person at the first designated location 110. For another example, the computer 300 may instruct the visual output device 135, 210 to display a sign language representation of the second text, e.g., as a holographic display of hands making signs for the words of the second text.

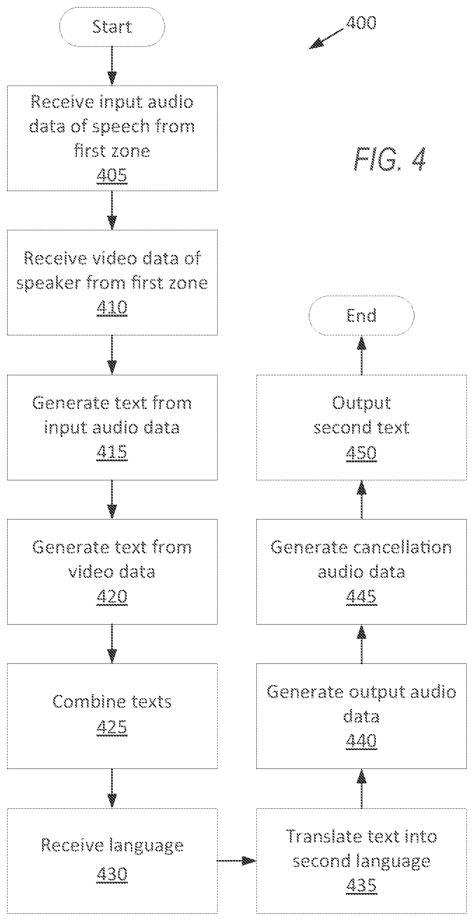

FIG. 4 is a flowchart illustrating an example process 400 for controlling the system 105. The memory of the computer 300 stores executable instructions for performing the steps of the process 400 and/or programming can be implemented in structures such as mentioned above. As a general overview of the process 400, the computer 300 receives the input audio data from the first designated location 110, receives the video data of the first designated location 110, generates the audio-based text from the input audio data, generates the video-based text from the video data, generates the first text from the audio-based text and video-based text, receives the first and second languages, translates the first text from the first language into second text in the second language, generates the output audio data from the second text, generates the cancellation audio data from the input audio data, and instructs the output device 125, 135, 210, 225 to output the second text, e.g., play the output audio data and the cancellation audio data or display the second text, to the second designated location 110.

The process 400 begins in a block 405, in which the computer 300 receives the input audio data of the first designated location 110 from the microphone 115, 215, as described above.

Next, in a block 410, the computer 300 receives the video data of the first designated location 110 from the camera 120, 220, as described above.

Next, in a block 415, the computer 300 generates the audio-based text based on the input audio data, as described above.

Next, in a block 420, the computer 300 generates the video-based text based on the video data, as described above.

Next, in a block 425, the computer 300 generates the first text based on the input audio data and the video data, e.g., by combining the audio-based text and the video-based text into the first text, as described above.

Next, in a block 430, the computer 300 receives and/or determines the first language and the second language, as described above.

Next, in a block 435, the computer 300 translates the first text from the first language to the second text in the second language, as described above.

Next, in a block 440, the computer 300 generates the output audio data from the second text, as described above.

Next, in a block 445, the computer 300 generates the cancellation audio data based on the input audio data, as described above.

Next, in a block 450, the computer 300 instructs the output device 125, 135, 210, 225 for the second designated location 110 to output the second text, as described above. For example, the computer 300 may instruct the speakers 125, 225 to play the output audio data and the cancellation audio data simultaneously, as described above. For another example, the computer 300 may instruct the display 135 or the user interface 210 to display the second text, as described above. After the block 450, the process 400 ends.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Python, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), a nonrelational database (NoSQL), a graph database (GDB), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In the drawings, the same reference numbers indicate the same elements. Further, some or all of these elements could be changed. With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. Operations, systems, and methods described herein should always be implemented and/or performed in accordance with an applicable owner's/user's manual and/or safety guidelines.

The disclosure has been described in an illustrative manner, and it is to be understood that the terminology which has been used is intended to be in the nature of words of description rather than of limitation. The adjectives “first” and “second” are used throughout this document as identifiers and are not intended to signify importance, order, or quantity. Use of “in response to” and “upon determining” indicates a causal relationship, not merely a temporal relationship. Many modifications and variations of the present disclosure are possible in light of the above teachings, and the disclosure may be practiced otherwise than as specifically described.

What is claimed is:

1. A system for a vehicle comprising:
a microphone focused on a first designated location of a first person with respect to the vehicle;
a camera with a field of view encompassing the first designated location;
an output device directed to a second designated location of a second person with respect to the vehicle; and
a computer communicatively coupled to the microphone, the camera, and the output device;
the computer being programmed to:
generate first text in a first language based on input audio data from the microphone and video data from the camera;
translate the first text to second text in a second language; and
instruct the output device to output the second text.

2. The system of claim 1, wherein the first designated location is exterior to and adjacent to the vehicle.

3. The system of claim 2, wherein the microphone is mounted to an exterior of the vehicle, and the field of view of the camera encompasses an area outside the vehicle.

4. The system of claim 1, wherein the first designated location is in a passenger compartment of the vehicle.

5. The system of claim 4, wherein the first designated location is in a seat of the vehicle, the microphone is positioned to receive audio from the first person sitting in the seat, and the field of view of the camera encompasses the seat.

6. The system of claim 1, wherein the second designated location is in a passenger compartment of the vehicle.

7. The system of claim 6, wherein the output device is a speaker, the second designated location is in a seat of the vehicle, and the speaker is mounted to the seat.

8. The system of claim 1, wherein the second designated location is exterior to and adjacent to the vehicle.

9. A computer comprising a processor and a memory, the memory storing instructions executable by the processor to:
generate first text in a first language based on input audio data from a microphone and video data from a camera, the microphone focused on a first designated location of a first person with respect to a vehicle, the camera having a field of view encompassing the first designated location;
translate the first text to second text in a second language; and
instruct an output device to output the second text, the output device directed to a second designated location of a second person with respect to the vehicle.

10. The computer of claim 9, wherein the instructions to generate the first text include instructions to generate audio-based text based on the input audio data, generate video-based text based on the video data, and combine the audio-based text and the video-based text into the first text.

11. The computer of claim 10, wherein the instructions further include instructions to generate an audio-based confidence level of the audio-based text and a video-based confidence level of the video-based text, and the instructions to combine the audio-based text and the video-based text into the first text include instructions to combine the audio-based text and the video-based text into the first text based on the audio-based confidence level and the video-based confidence level.

12. The computer of claim 11, wherein the audio-based text includes a sequence of audio-based words, the video-based text includes a sequence of video-based words, the audio-based confidence level includes a sequence of audio-based confidence values for the respective audio-based words, and the video-based confidence level includes a sequence of video-based confidence values for the respective video-based words.

13. The computer of claim 12, wherein the instructions to combine the audio-based text and the video-based text into the first text includes instructions to select a word for the first text from either the audio-based words or the video-based words according to which of the respective audio-based confidence value or video-based confidence value is greater.

14. The computer of claim 9, wherein the instructions to generate the first text include instructions to execute a speech-to-text algorithm on the input audio data.

15. The computer of claim 9, wherein the instructions to generate the first text include instructions to execute a lip-reading algorithm on the video data.

16. The computer of claim 15, wherein the lip-reading algorithm outputs video-based text, and the instructions to generate the first text include instructions to execute a speech-to-text algorithm on the input audio data to output audio-based text, and combine the audio-based text and the video-based text into the first text.

17. The computer of claim 9, wherein the output device is a speaker, and the instructions further include instructions to generate output audio data from the second text, and to instruct the speaker to play the output audio data.

18. The computer of claim 17, wherein the instructions further include instructions to generate cancellation audio data based on the input audio data, and instruct the speaker to play the cancellation audio data.

19. The computer of claim 18, wherein the instructions further include instructions to instruct the speaker to play the output audio data and the cancellation audio data simultaneously.

20. A method comprising:
generating first text in a first language based on input audio data from a microphone and video data from a camera, the microphone focused on a first designated location of a first person with respect to a vehicle, the camera having a field of view encompassing the first designated location;
translating the first text to second text in a second language; and
instructing an output device to output the second text, the output device directed to a second designated location of a second person with respect to the vehicle.
